(19) United States
(12) Patent Application Publication
(10) Pub. No.: US 2011/0180368 A1
(43) Pub. Date: Jul. 28, 2011

(54) Fruit and vegetable distributor system

(76) Inventor: Douglas Eugene Rockstead, Harlingen, TX (US)

(21) Appl. No.: 12/930,895

(22) Filed: Jan. 19, 2011

Related U.S. Application Data
(60) Provisional application No. 61/336,687, filed on Jan. 25, 2010.

(51) Int. Cl. B65G 47/76; B65G 47/74

(52) U.S. Cl. 198/367

(57) ABSTRACT

An automatic packaging apparatus for rapidly, accurately and gently distributing randomly oriented objects, such as fresh fruits and vegetables, into multiple packaging machines.

### CROSS REFERENCE TO RELATED APPLICATIONS

This application claims the benefit of U.S. provisional Ser. No. 61/336,687 filed Jan. 25, 2010.

### FIELD AND BACKGROUND OF THE INVENTION

1. Field

This disclosure relates to the feeding and distribution into multiple packaging machines of articles that are substantially round, such as tomatoes, citrus fruits, apples, onions, potatoes, cucumbers, and peppers especially objects which are not geometrically similar or spherical (such as most fruits), as well as any other approximately spherical products, whether natural or manufactured.

2. Background

Fresh fruits, vegetables, and other relatively soft and/or fragile objects are routinely fed into various package or containers. Various means, ranging from fully manual sorting and feeding to much more automatic means have been employed to do this.

U.S. Pat. No. 3,705,475 describes a packaging machine system in which a bulk supply of articles to be packaged are fed into a plurality of single files and held in alignment to be fed into a series of packaging machines. This approach, and many other automated packaging systems, requires complex and expensive mechanisms in an industry in which low cost approaches are needed.

There is a need for a more straightforward means to automate this activity and be able to handle large quantities of articles to be packaged from a straightforward conveyor belt system.

These needs are met by the system described here.

### SUMMARY OF THE DISCLOSURE

The need is met by a straightforward series of automated diverters deployed onto a long conveyor belt. The diverters are automated by a simple feedback mechanism that systematically arranges the diverters in response to signals from the packaging machines. The system further uses only air pressure signals to systematically open and close diverters by a prescribed amount—and can be done without motors or electrical drivers. The system described can be used with existing packaging machines and diverters that are already in common use in this industry, but often operated manually.

The needs are met by a controller (200) for opening and closing a diverter blade (260) that feeds produce into packaging machines (130) including at least an extended frame (205) that is pivotally attached at a first end to the sidewall of a produce conveyor belt (110) and extends across said conveyor belt; a toothed ratchet wheel (220) attached at said first end of said extended frame; a toothed idle ratchet wheel (230) attached at a second end of said extended frame; a chain (240) that extends along said extended frame and continuously loops around said drive sprocket and said idle sprocket and engages the teeth of both sprockets; a crawler (250) that sits atop said chain and moves as the chain moves, said crawler attached to said diverter blade below said extended frame and said crawler including a toothed ratchet wheel and pawl mechanism (225) that engages the chain, said ratchet and pawl mechanism having a first drive mechanism (270) that operates to move said diverter toward an open position when said first drive mechanism operates; a ratchet wheel and pawl mechanism (255) that engages the teeth of said wheel sprocket at the first end of said extended frame and is driven by air pressure by a second drive mechanism (280) that operates to move said diverter toward a closed position when said second drive mechanism operates; wherein said first drive mechanism 270 is responsive to a signal from the next downstream packaging machine; and wherein said second drive mechanism 280 is responsive to a signal from the current packaging machine.

The needs are also met when the first and second drive mechanisms are air cylinders and are met when they are solenoids.

### BRIEF DESCRIPTION OF THE SEVERAL VIEWS OF THE DRAWING

The following drawings form part of the present specification and are included to further demonstrate certain aspects of the system described here. The system described here may be better understood by reference to one or more of these drawings in combination with the detailed description of specific embodiments presented herein.

FIG. 1 illustrates an overall feed system of the prior art.

FIG. 2 illustrates the diverter controller of the present invention.

FIG. 3 illustrates the control strategy of three diverter controllers in sequence.

### DETAILED DESCRIPTION OF THE INVENTION

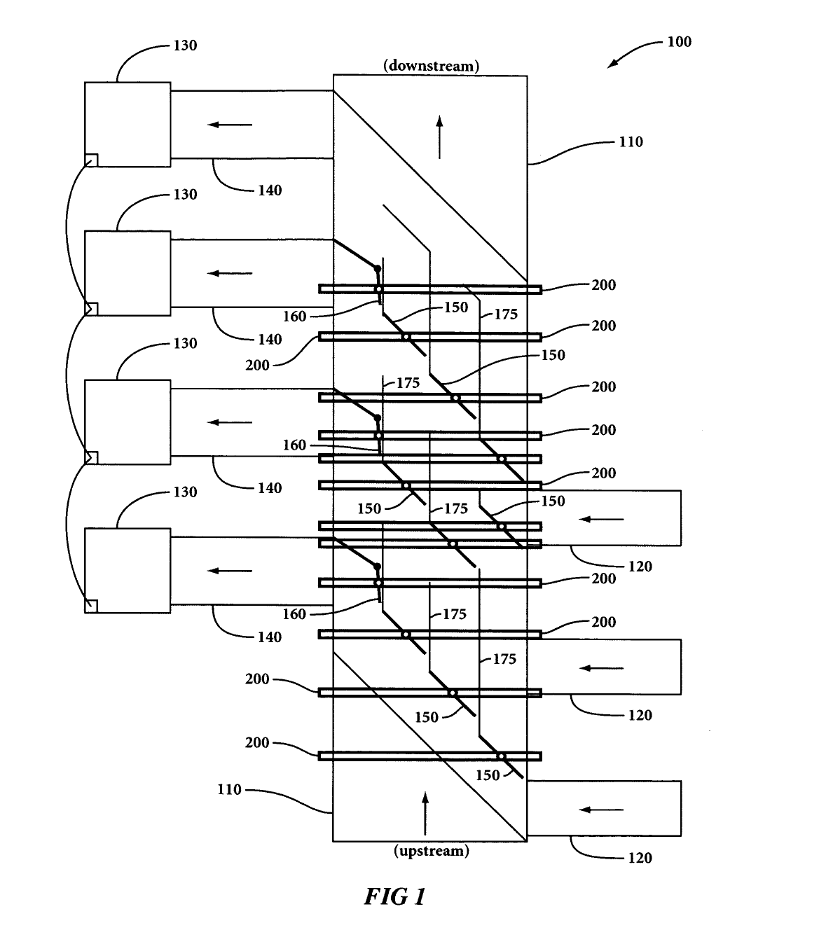

Preferred embodiments and their advantages are best understood by reference to FIGS. 1 through 3

FIG. 1, illustrates a typical conveyor belt feed system 100 for a series of packaging machines. The broad conveyer belt 110 moves from bottom to top of the drawing. From the right hand side of the drawing are a series of smaller conveyor belts 120 that bring in the fruits or vegetables from the field. These may be fed directly from trucks, or by other means. On the left hand side are a series of packaging machines 130 which accept the fruits or vegetables (produce) directly from conveyors 140, which may be a series of rollers. The overall flow of produce is from right to left on the drawing. A variety of packaging machines 130 are available in the industry and the particular choice of machines is not part of this invention.

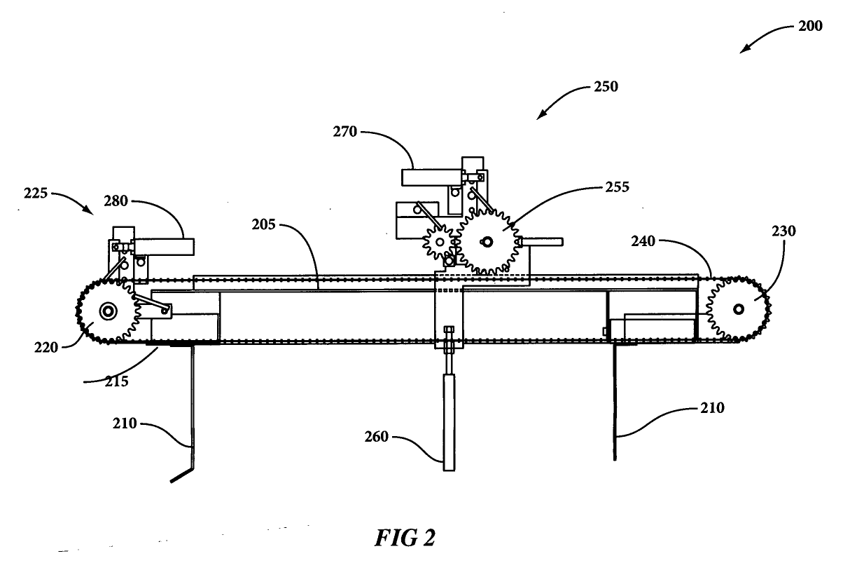

The flow of produce from right to left is controlled by the placement of diverters 150,160. The produce flows generally from the bottom of the drawing (upstream) to the top (downstream) from the movement of the main conveyor belt 110. The flow is downstream through fixed walls 175. These walls have periodic “doors” made up of the diverters 150, 160 which open and close to direct the flow of produce toward conveyors 140. The diverters are typically adjusted manually by human operators from observation of the needs of the packaging machines. In FIG. 1 though the diverter controllers 200 of the instant invention control the diverters. The inverter controllers will be described in FIG. 2.

Diverters 150 are straight rigid planes and are attached at a first end to central walls 175. The diverters 160 along the left hand side of conveyor belt 110 are attached at one end to the left sidewall of conveyor belt 110 and then pivot at a mid-point. In FIG. 1 an embodiment is shown in which there is a diverter controller 200 on every diverter. In practice though any number of configurations could be used to minimize the number of diverter controllers. For example many of the diverters 150 could be set in either an open or closed position depending on the number of machines 130 in use and diverter controllers installed only on the diverters 160.

FIG. 2 illustrates the principle mechanism of the invention, one of a series of identical and independent diverter controllers 200 that are mounted across the side rails 210 of conveyor belt 110 of FIG. 1, one for each diverter to be moved. With respect to FIG. 1 each diverter controller 200 is mounted on an extended frame 205 that is pivotally attached to the side rail on the left side of FIG. 1 at the pivot point 215 and then extends across the conveyor belt 110. Diverter controller 200 has a toothed drive sprocket wheel 220 on one end and a toothed idle sprocket wheel 230 at the other end with a chain 240 that loops around both wheel sprockets. A sprocket on crawler 250 is engaged on the chain and crawls in the opposite direction. The crawler 250 is attached below the bottom of the chain to a center point on its associated diverter so that the crawler movement pivots its diverter toward or away from the wall 175 it is connected to.

The packaging machines 130 (FIG. 1) can operate pneumatically, or by other means. For purposes of this description a pneumatic mechanism is described. A signal operates an air cylinder that transfers a filled box or package out of the machine. Crawler 250 and wheel sprocket 220 have drive mechanisms that acts to drive their sprocket mechanisms. These drive mechanisms can be pneumatically or electrically driven, such as with a solenoid, or by any means that will move the sprocket. The invention anticipates any of these mechanisms. For description purposes the use of air cylinders that provide pneumatic force will be used but the invention is not limited to pneumatic.

Drive mechanism 270 on crawler 250 is connected to and receives a signal caused by a function of the machine immediately downstream from the machine being fed by the diverter attached to crawler 250. Drive mechanism 280 on drive sprocket 220 is connected to and receives a signal fed by a function of the machine being fed by the diverter attached to crawler 250. In operation then when the packaging machine immediately downstream from the machine being fed by the diverter attached to crawler 250 cycles then drive mechanism 270 receives that same signal and acts to move the crawler to the right (in FIG. 2) by a fixed amount opening the shear slightly (typically about ½ inch). Similarly, when the packaging machine or other function being fed by the diverter attached to crawler 250 cycles then drive mechanism 280 receives that same signal and acts to make the drive sprocket pull the crawler to the left (in FIG. 2) by a fixed amount closing the shear slightly (typically about ½ inch).

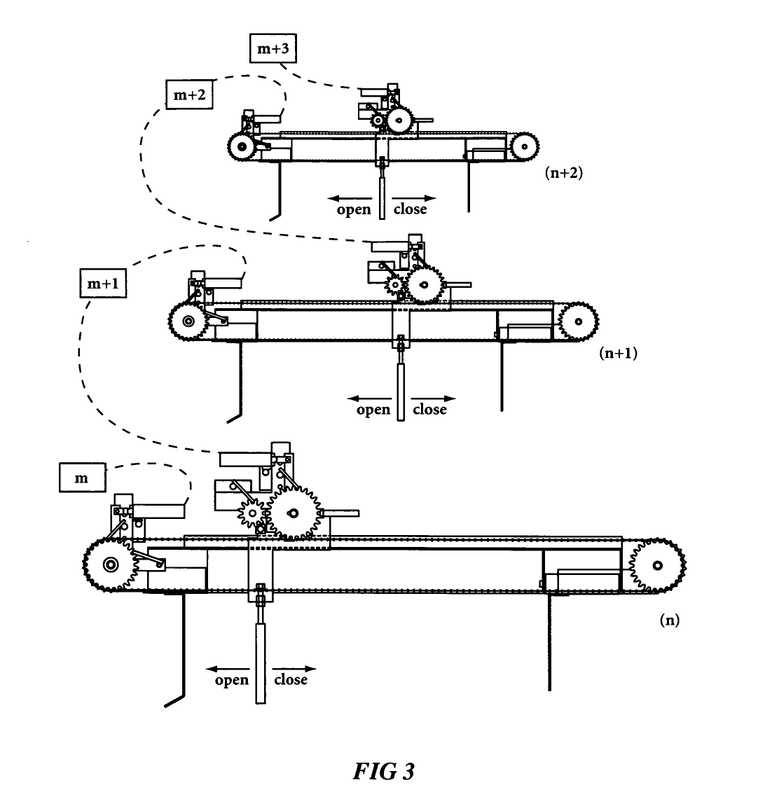

This methodology is made clearer by reference to FIG. 3. Three consecutive diverter controllers (n, n+1, n+2) are shown. Each associated with a packaging machine (m, m+1, m+2). When packaging machine m+1 transfers out a filled box, or other function, it simultaneously sends a signal to the crawler drive mechanism of diverter controller n and to the drive sprocket drive mechanism of diverter controller n+1. This controller strategy applies to the complete assembly of diverter controllers shown in FIG. 1.

The actual back and forth movement of the crawler is accomplished by two ratchet and pawl mechanisms on each diverter controller. One 225 is fixed on the end of the diverter controller to control wheel sprocket 220 and the other 255 attached to the crawler 250 and diverter 260. Ratchets and pawls are mechanical assemblies that are used to transmit intermittent rotary motion, or to permit a chain to rotate in one direction but not the other. Ratchets and pawls are usually made of steel, stainless steel, cast iron, brass, or other metal materials. Ratchets are sometimes called ratchet wheels because they consist of a rotating gear or rack with angled teeth. Pawls are thin protrusions that rest against a ratchet to restrict its motion. When the ratchet is rotated in one direction, the pawl is raised and moves smoothly between the angled teeth. When the ratchet's rotation stops, the pawl rests between the teeth. Ratchets and pawl that permit rotation in only one direction cause the pawl and teeth to clash if the ratchet is turned the opposite way. In the implementation of the present invention the ratchet and pawl assembly of sprocket 220, when activated by drive mechanism 280 moves the chain in one direction only. The ratchet and pawl assembly 255 of crawler 250, when activated by drive mechanism 270, moves the crawler in the opposite direction. It is understood that a number of ratchet and pawl configurations can be designed to accomplish this task and all are anticipated by this invention.

Each time a packaging machine 130 completes a batch of produce it sends a signal to the divertor feeding that machine to close by a fixed amount and a signal to the diverter upstream of it to open by a fixed amount. It has been found that this simple control approach quickly reaches an optimum feeding strategy that maintains a steady feeding of packaging machines 130, irrespective of the changing feeds coming from feed conveyor belts 120.

Diverter controllers 200 can simply be added to any produce diverter feed system, one controller per diverter, and require no motors, as the powering mechanism for each is two drive mechanisms 270,280 that could be simple air pressure cyclinders, solenoids, or other drivers that receive their signals from the packaging machine they are feeding and the immediate downstream machine. Drive mechanism 280 acts on wheel sprocket 220 and drive mechanism 270 acts on crawler 250; in each case triggering a simple further opening or closing of a diverter.

All of the methods disclosed and claimed herein may be executed without undue experimentation in light of the present disclosure. While the disclosure may have been described in terms of preferred embodiments, it will be apparent to those of ordinary skill in the art that variations may be applied to the components described herein without departing from the concept, spirit and scope of the disclosure. All such similar substitutes and modifications apparent to those skilled in the art are deemed to be within the spirit, scope, and concept of the disclosure as defined by the appended claims.

1. A diverter controller (200) for opening and closing a diverter blade (260) that feeds produce into packaging machines (130) comprising:
a. an extended frame (205) that is pivotally attached at a first end to the sidewall of a produce conveyor belt (110) and extends across said conveyor belt;
b. a toothed ratchet wheel (220) attached at said first end of said extended frame;
c. a toothed idle ratchet wheel (230) attached at a second end of said extended frame;
d. a chain (240) that extends along said extended frame and continuously loops around said drive sprocket and said idle sprocket and engages the teeth of both sprockets;
e. a crawler (250) that sits atop said chain and moves as the chain moves, said crawler attached to said diverter blade below said extended frame and said crawler including a toothed ratchet wheel and pawl mechanism (225) that engages the chain, said ratchet and pawl mechanism having a first drive mechanism (270) that operates to move said diverter toward an open position when said first drive mechanism operates;
f. a ratchet wheel and pawl mechanism (255) that engages the teeth of said wheel sprocket at the first end of said extended frame and is driven by air pressure by a second drive mechanism (280) that operates to move said diverter toward a closed position when said second drive mechanism operates;
wherein said first drive mechanism (270) is responsive to a signal from the next downstream packaging machine; and
wherein said second drive mechanism (280) is responsive to a signal from the current packaging machine.

2. The diverter controller of claim 1 wherein said first and second drive mechanisms are air cylinders.

3. The diverter controller of claim 1 wherein said first and second drive mechanisms are electric solenoids.
